(19) United States
(12) Patent Application Publication
(10) Pub. No.: US 2018/0059704 A1
(43) Pub. Date: Mar. 1, 2018

(54) ZPE MAGNETIC BATTERY

(71) Applicant: Victor M. Villalobos, Pensacola, FL (US)

(72) Inventor: Victor M. Villalobos, Pensacola, FL (US)

(21) Appl. No.: 15/330,224

(22) Filed: Aug. 25, 2016

(51) Int. Cl. G05F 3/08; H02J 7/00

(52) U.S. Cl. CPC G05F 3/08; H02J 2007/0059; H02J 7/0052

(57) ABSTRACT

The patent describes a ZPE Magnetic Battery which uses inductors oscillated at high frequencies to harvest induced current potential from the ZPE General space-time plenum.

The ZPE Magnetic battery uses Unipolar magnetic potential which can be stored and harvested while being converted into bipolar usable electrical potential energy by using super-capacitors thru storage which uses the Casimir principles.

Uniquely the battery consumes magnetic energy provided by the ZPF instead of electrical potential generated from chemical means thus preserving the battery charge.

### CROSS-REFERENCE TO RELATED APPLICATIONS

This application claims the benefit of the filling date of U.S. Provisional Application No. 62/391,852 submitted on May 12, 2016 and U.S. Non-provisional application Ser. No. 14/999,738 submitted on Jun. 21, 2016 of which the entirety of the contents of both applications are being hereby expressly incorporated by reference.

### INTRODUCTION

This patent presents the apparatus and the methods required to assemble a ZPE Magnetic battery that utilizes electrical current collected as ZPE Magnetic fuel from the ZPF environment. The device utilizes ZPE induced currents obtained from the ZPF as the main potential to power electrical loads in total contrast with regular electrical batteries which consumes positive ions produced by chemical reactions of today's electrical batteries.

The ZPE Magnetic battery power electrical loads by consuming Unipolar induced currents collected from the ZPF environment unburdening the Electrical chemical battery.

The patent describes a ZPE magnetic battery made out of simple circuits and apparatus that can be assembled at low cost with minimum resources which prove without a doubt the feasibility and viability of a better and novice Magnetic battery device which taps the potential of the predicted ZPE Vaccum which surrounds us as a source of magnetic energy.

This patent holds all evidence neccesary to conclusively prove a number of prior assertions and notions which validitate the ZPE and ZPF claims. A great number of prior claims of theoretical nature regarding ZPE have been put forward in the past, these claims can be proven with the enclosed discovery material and with simple experiments without large particle accelerators or sophisticated equipment and without much difficulty.

“Usable electrical potential can be extracted from the ZPE vaccum by exposing inductors to electromagnetic disturbances (ZPE electromagnetic Vaccum-fluctuations) which evoke a radiation effect made of Unipolar induced currents that can be stored with Super-capacitors”.

ZPE electromagnetic fluctuations are produced by inductors themselves which invoke a counter-measure in the form of induced unpolar energy currents of suplemental nature. The inductor acts like the initiator and the recipient of the ZPE energy and essentially becomes an antenna which receives unipolar induced currents from the ZPF. The received Unipolar potential can then be harvested and stored in Super-capacitors banks.

Super-capacitors stores the Unipolar potential under the Casimir effect theory which creates an “electrostatic pressure potential” which can be used as electrical potential. The stored potential is made out of an electrostatic pressurized potential which ratifies the Casimir effect theories.

The key element is the Faraday's Unipolar induction current which favors to be stored in super-capacitors, the inductor member produces Unipolar induced currents when exposed to magnetic disturbances in the form of vaccum-fluctuations. The super-capacitors convert and store the Unipolar potential as to a form a type of “electrostatic cold pressure type of potential” that behaves just like electrical potential without the heat of ohmnic malignant currents.

By using large banks of super-capacitors in series and parallel, enormous quatities of cold electrostatic and electrical current energy can be stored at high frequencies upon demand thus providing unlimited amounts of energy, the amount of energy held by super-capacitors can be large and it can be portable and very scalable.

Therefore, based on actual prototypes built, the ZPE energies are clearly available in large amounts and only limited by the size of the DC power supplied, the capacity of the inductors and the size of the super-capacitor banks to store it.

The required DC power supply can be any DC source including DC obtained from AC potential, this includes solar DC potential as well as other hybrid battery-supercapacitors means of DC storage.

### ZPE and ZPE Theories

Zero point Field (ZPF) and Zero point energy (ZPE) are modern notions that have been under development for the last one hundred years and the latest experimentation has proved that we are surrounded by an energetic magnetic substance which contains latent EMF energy which surround us at uniform levels (like being submersed in water) in an all pervasive manner like the Gravity which surround us now which we only feel when accelerating(inertia).

In fact, the ZPF energy becomes detectable only when electrical charged particles are accelerated or decelerated through space. The more acceleration change the more detectable.

Fundamentally, we are unable to detect the ZPF and ZPE aspects visually or in any other manner because the lack of asymmetry of the ZPF which prevents to see it or identify it, just as a fish being absolutely still in a sea of constant temperature and pressure water which is unable to detect the water itself.

Our knowledge of these notions of ZPE and ZPF have increased in the last years and now both notions are generically accepted as intrinsic parts and mechanics of the universe. Clearly, this is a new branch of Physics which theoretically represents the difference between stochastic electrodynamics and ordinary classical physics.

The Zero-Point Field (ZPF) is a vacuum field as what is commonly thought of as empty space where all thermal radiation ceases at a temperature of absolute zero. In theoretical terms the background energy of the vacuum serves as the reference zero point for all processes while the Zero-Point Energy (ZPE) represents a radiation that is latent in nature which holds enormous amounts of energy (potential difference).

Theoretical considerations indicate that the ZPE exists in a background sea of electromagnetic radiation that is both uniform and the same in all directions. It is likely necessary to go beyond a simple, constant acceleration through space (in order to detect the ZPF), and instead, a transition into a varying acceleration in order to tap into the energy of the ZPF. In this case, we can assume with a reasonable confidence that the greater the change in acceleration, the greater the energy derived from the ZPF and that is the need for high frequency oscillations in the order of 100 KHertz.

Physicists Paul C. W. Davies and William G. Unruh, showed in the mid 1970s that a moving observer distorts the ZPF and ZPE spectrum by accelerating through the field. Furthermore, he showed that this distortion increases with increasing acceleration. Extending these findings would suggest highly variable accelerations produced by high frequencies could provide very large distortions, and that these distortions could be used as an energy source.

In this regard, it has been shown that when an electromagnetically interacting particle is accelerated through the ZPF, a force is exerted on the charge in the opposite direction. Furthermore, the radiated force is proportional to the acceleration, but acts in the direction opposite to it. I.e., the charge experiences an electromagnetic force as resistance to acceleration. Which is the equivalent of the inertia of a massive particle, what Sir Isaac Newton regarded as an innate property of matter. Importantly, this allows for the idea that Newton's Second Law (i.e. F=ma) can be derived from the laws of electrodynamics, provided one assumes a ZPF.

What is seen as inertia is nothing more than an effect caused by stored electromagnetic forces acting on a charge. In effect, charge and its interaction with the ZPF creates what we experience as mass.

Andrei D. Sakharov suggested as much in 1968, an idea which was addressed 20 years later by Puthoff. Using stochastic electrodynamics, Puthoff showed that if a charged particle is subjected to ZPF interactions, it fluctuates.

These fluctuations result in electromagnetic fields, which have an attractive force between them. These forces are much weaker than the electromagnetic attractive or repulsive forces between electric charges but because of their additive nature, these forces can be collected and stored in super-capacitors as useful potential.

The fluctuations are relativistic in nature and moving at velocities at or close to the speed of light and can yield Unipolar energy as a result of the acceleration and inertia force effect produced by the fluctuations (high frequencies) of the implied mass of the ZPF. The energy associated with the fluctuations can then be interpreted as implied mass that accelerates and decelerates at great rates of frequency.

The ZPF can be thought of as a sea of radiation that fills the entire universe which is sensitive to “fluctuations” of the ZPF. It involves highly energetic emissions produced by low investments of electronically produced fluctuations of the ZPF density rising proportional to the cube of the frequency of the radiation. This implies that by doubling the frequency, the energy increases by a factor of eight.

Because the energy density of the ZPF increases as the cube of the frequency, the amount of energy ex-tractable from the ZPF is enormous. That energy, in the conventional view, is forced into existence by the laws of quantum mechanics.

### Casimir Effect

It was the Dutch theoretical physicist Hendrik Casimir (1909-2000) who first realized that when two mirrors face each other in a vacuum, fluctuations in the vacuum exert “radiation pressure” on them. The internal force is proportional to the Area and distance (F˜A/d), where A is the area of the mirrors and d is the distance between them.

The arrival of quantum mechanics, however, completely changed our notion of a vacuum. All fields, in particular electromagnetic fields, have fluctuations. In other words at any given moment their actual value varies around a constant, mean value. Even a perfect vacuum at absolute zero has fluctuating fields known as “vacuum fluctuations”,

An important physical quantity when discussing the Casimir force is the “field radiation pressure”. Every field, even the vacuum field, carries energy. As all electromagnetic fields can propagate in space they also exert pressure on surfaces, just as a flowing river pushes on a floodgate. This radiation pressure increases with the energy and hence the frequency of the electromagnetic field is a factor. At a cavity-resonance frequency the radiation pressure inside the cavity is stronger than outside and the mirrors are therefore pushed apart. Out of resonance, in contrast, the radiation pressure inside the cavity is smaller than outside and the mirrors are drawn towards each other.

It turns out that, on balance, the attractive components have a slightly stronger impact than the repulsive ones. For two perfect plane parallel mirrors the Casimir force is therefore attractive and the mirrors are pulled together. The force, F, is proportional to the cross-sectional area, A, of the mirrors and increases 16-fold every time the distance, d, between the mirrors is halved: F˜A/d.

The fact that an attractive force exists between two conducting metal plates was first predicted in 1948 by Hendrik Casimir of Philips Research Laboratories in the Netherlands. At the time, however, Casimir was studying the properties of “colloidal solutions”. Casimir noticed that this result could be interpreted in terms of “vacuum fluctuations” and it was this work that led to his famous prediction of an attractive force between reflecting plates.

### BRIEF DESCRIPTION OF THE NEW ART

The patent describes a ZPE Magnetic battery apparatus which uses electrical potential and oscillated inductors to extract electrical potential in the form of induced currents from the magnetic environment thru the extraction of Unipolar electromagnetic potential from the ZPF environment which can produce Vacuum-fluctuations in the magnetic plenum as described by ZPE and ZPF theories. The ZPE magnetic battery apparatus can be transportable and scalable to be as small or as large as needed to generate the desired output.

Electro-magnetic ZPE Vacuum-fluctuations are magnetic disturbances produced by either pulsing inductors with electrical pulses or by applying unbalancing disruptive magnetic pulses into a charged inductor in a circuit. Upon the ZPE Vacuum-fluctuation disturbance ceasing, the environment responds with an Unipolar induced current pulse which “contains induced current energy” and which can be stored in the Super-capacitor.

The “Unipolar” potential (so called since it holds potential in a single electrode only) is a kin of the electrostatic potential which can be either positive or negative potential which when mixed together with negative Unipolar electrical potential can form the common bipolar electrical potential that we use today as electrical energy.

Unipolar potential current as its name implies acts thru one pole only (either positive or negative) thus it is unable to produce bipolar current and thus highly immune to consumption. The Unipolar potential current (Positive and negative) can be used to charge super-capacitors with a type of electrostatic “pressure” which promotes the acceleration of other electrically charged particles which produces potential which can be converted to bipolar electro-magnetic potential thru storage and which is usable electrical potential.

Uniquely, Unipolar potential can be generated (as an extraction from the ZPF) by exposing inductors to “ZPF magnetic Vacuum-fluctuations” at high frequencies as low burden energy expenditures and returning as higher current potential to the battery thus providing a free energy method to generate Unipolar potential while maintaining the source.

The Unipolar potential is unusable to do work in its natural form and must be converted to usable bipolar potential using super-capacitors.

### Casimir Effect and ZPE Aspects

Within the framework of Special Relativity (SR) and as per ZPE theories, space-time is permeated and held together by latent electromagnetic energy. The ZPE energy exists in the form of a pervasive “vacuous-fluctuations” energy which holds enormous amounts of energy.

Tesla recognized a “radiant energy” without definition or details of its actual contents in his Patent #685,958; however, even when he was able to recognize the Unipolar value of what he called “radiant energy” but he was unable to utilize the true nature of what he called radiant energy as a true “magnetic monopole”.

The patent discloses methods and apparatus as a ZPE Magnetic battery which extracts electro-magnetic potential in the form of Unipolar potential from the General space-time plenum (Vacuum-fluctuation plenum) by producing electromagnetic radiating events within the local time plenum.

The patent as part of its discovery discloses a novice method to convert the electrical energy to unipolar induced currents where the positive Unipolar potential extracted from the space-time plenum and the electrical potential from a regular DC electrical source are united to form bipolar usable potential which is stored super-capacitors.

As per Einstein's General relativity, the Universe is held together by a fabric made out of time and space, and where every point in the Universe holds latent electromagnetic energy. The General space-time is made out of space and time forming an Euclidean shell shape lines of force which forces “mass” to adopt behaviors such as gravity, space orbits and the falling of weights to a lower plane.

Inductors members invoke electro-magnetic energy transfers from the time-space plenum when energized and de-energized using high voltage and high frequency pulses.

Inclusively, experimenters working on the Biefield-Brown effect of Gravity, have observed an implied “mass-gained effect” when working with inductors. By the mass-energy equivalence principle, if mass is increased in a system, then potential is also increased.

Within the framework of Special Relativity (SR), the General space-time plenum can provide electromagnetic potential as usable electrical potential in a manner which is plentiful, readily available, compact and it is easily transportable as an energy source.

The Induced electro-magnetic current effect was initially discovered in the 1800's by Ampere and Faraday separately and corroborated later by Weber who discovered independently a distinct unexpected electrical response from experiments dealing with rotating magnetized ferrous cylinders being submerged in mercury on one side and in contact with a continuous electrical loop. At the time, the researchers were unable to recognize the true nature or the value of their discovery. Weber did in 1843 recognized a distinct magnetic “mono polar” property in the currents he observed.

At the time, they were unable to recognize the potential relationship of the induced current effect observed with the formation of a possible “magnetic monopole”, even when they observed unexpected “unusual different results”, they failed to understand that their discovery was essentially tapping to a potential dynamic magnetic mono polar “fuel source” which can supply with free energy.

Even today, our scientific community is still seeking for that elusive “monopole magnet”, this patent will show that the much desired “magnetic monopoly” has been hiding in plain view.

While our entire scientific community continues to look for a hard like “static magnetic monopole” (one pole magnet). This patent discloses the methods to create magnetic monopoles which exist in a dynamic state that carries an implied mass state.
This patent discloses the methods and apparatus required to create a ZPE Magnetic battery and the methods to extract potential from it.

This patent deals and expounds on the fact that there is a General three-dimensional space-time plenum and a local space-time which resembles a point, the space in between contains latent electromagnetic energy. This patent mainly deals with methods of extracting energy from the General space-time in the form of Unipolar induction currents delivered to the local space-time magnetic energy plenum around us.

### The Mechanical Equivalent of an Inductor is Mass

In terms of Einstein's theories and Space-time, the mechanical analogy of an inductor is a mass. The voltage developed across an inductor corresponds and it is proportional analogous to the force required to accelerate a mass. The current through an inductor corresponds to the velocity of the mass. Thus, Eq. 101, corresponds to Newton's second law for an ideal mass where,

Force=mass*acceleration. (eq. 101)

Physically what is happening is exactly the same as what happens when a force is applied to a mass to accelerate it.

F=m*(a) and VL=L*(di/dt) (eq. 102)

Electrical inductance (L) is analogous as physical or inertial mass where electrical current is the same as velocity, (di/dt) is acceleration.
From the defining equation for an inductor, we see that the stored magnetic flux in an inductor is analogous to mass times velocity, or momentum. In other words, magnetic flux may be regarded as electric-charge momentum.

### Implied Inertial Mass Effect of Inductors

Electromagnetic experiments dealing with space curvature and the Biefeld-Brown Gravity effect which use capacitors and inductors report having observed mass effects with inductor coils of fixed inductance L. The experimenters have observed increases of current of the inductors coil circuit implying that there is an increase-like of mass effect when energized.

When all the electric-magnetic field waves and geometry elements of an inductor including the Frequency-Mass-Energy electromagnetic concepts are lumped into one number—the inductance, L (inductance) defines the ratio relationship between the voltage (electrical field) applied to an inductor and the resulting current flow can be expressed very simply as:

V=(−) L(di/dt) where (di/dt) is the rate of change of current and is related to the magnetic field wave oscillation which encompasses the frequency of electromagnetic waves.

A changing magnetic field wave creates an electric field wave and vice versa as per Lenz' law of Self-inductance or also known as Mutual inductance. This is the basis for powering transformers and electric power generation. If one coil of wire (or one electromagnet) is placed close to another, an increasing current flow is established in the first coil, which creates an increasing magnetic field.

The changing magnetic field as a magnetic flux creates an electric field electric flux directly in the wire (and in all other regions of space and vacuum nearby). The amount of voltage generated is proportional to the total length of wire in all the loops and the magnitude of the magnetic field. Electric fields exist parallel to the conductor and the magnetic field exist perpendicular to it.
A Word about Super-Capacitors

Ultra-capacitors and super-capacitors, unlike regular capacitors, store both electrical potential and magnetic current potential. Regular capacitors only store electrical potential.

Ultra-capacitors and super-capacitors, store electricity by physically separating positive and negative charges while batteries do so chemically.

Super-capacitors are charged by electrical current and hold the charge in a manner similar to static electricity like inflating a balloon in an aggregation fashion, but where the potential is aggregated without any resistance thanks to the extremely high surface area of their interior dielectric materials.

Super-capacitors physical composition is similar to two regular capacitor back to-back, one capacitor holds the positive charge and the other one holds the negative charge or vice versa, the potential is separated by a dielectric divider making an ideal device to store Unipolar potential which converts Unipolar potential to bipolar potential.

Applying a voltage across the super-capacitor's double electrodes causes the ions in the electrolyte to migrate in an attempt to reverse the charge on the electrodes (the charging part of the cycle). Positively charged ions move to the negative electrode and negatively charged ions move the positive electrode, forming two charged layers inside the electrolyte: one positive and one negative.

The capacitive values of super-capacitors are determined by their size, geometry and composite materials. Latest super-capacitors offers a capacitance values up to 200 F. Super-capacitors main property is the one of having a low ESR (Equivalent Series Resistance which use ion migration inside a thin membrane of activated carbon to store electrical charges.

In this patent super-capacitors low equivalent series resistance (ESR) play an extremely important role of merging Unipolar potential from two different sources thus not consuming either source. The positive super-capacitor charge is unilateral potential obtained from the inductor as positive Unipolar current potential and the negative potential is obtained from an electrical source. Unipolar potential is aggregated at both pseudos capacitors separately and the potential is linked by the super-capacitor dielectric.

### Nature Works Thru Unipolar Potential Monopoles

Evidence learned from the practical aspects of the patent is that Nature itself and the ZPE energy principle works thru a system of Unipolar potential forces.

Nature manages a multitude of forces of immense energy and power in our Universe. We recognize that nature has at its disposal major amounts of energy and forces of great power such as very energetic electrical storms which balances the weather in our atmosphere and which charges electrically our atmosphere, as well as the gravity forces which keep masses and galaxies together in the Universe, and this includes the electrostatic electricity energy which promotes rain and precipitates rain in the clouds, etc, etc. And deep in outer space, gigantic electro-magnetic storms are developed and those, as well, are developed with “magnetic energy” in the form of Unipolar potential.

Nature always acts thru balanced monopoles of potential (not bipolar). Our bipolar potential is an invention of our own. On the other hand, in its wisdom, our Universe uses natural mono-polar energy exclusively as the simpler format to transfer forces and energy, possibly because is a simpler format and because it is harder to destroy. Ironically, the Universe does not like “monopoles” created by other mechanisms and does anything to balanced “monopoles” created by charged particles accelerating or magnetic bodies moving.

Nature has immense quantities of energy which can be tapped if extracted as Unipolar potential. Electromagnetic Unipolar energy can be extracted in the form of mono-polar inductive currents, primarily for “capacitive” and “inductive” circuits, which store energy.

Generically speaking, Nature's forces are mainly delivered in the form balanced Unipolar or monopole natural potential. Mono-polar potential lacks a “ground” and it is somewhat unusable in its monopole Unipolar natural state, and even when monopoles can be the gate to large amounts of clean energy for mankind, Unipolar potential is useless to us unless it is converted to “bipolar energy”.

This patent discloses the methods and apparatuses to avail access to the energy of space-time and the how to convert “Unipolar magnetic” energy into useful potential. Given the present patent technology, humanity will be able to avail large amounts of energy which taps and converts this immense “monopole energy source” to “usable bipolar energy”.

### Elements of an Electromagnetic Radiant Event

An electromagnetic radiating event occurs whenever a magnetized mass is moved or a charged particle is accelerated (Ampere's taw). This is the physics Laws behind the “homo-polar” and an “inductors” induced current.

An electromagnetic event like a charged particle accelerating (v*ds/dt) from an electric pulse represents an electromagnetic unbalance to the space-time fabric as an unbalanced “monopole” made out of mass and an electric field. As a countermeasure, the space-time provides electromagnetic energy to convert it into a balanced “monopole”. Once the Vacuum-fluctuation disturbance pulse ceases, this monopole contains pure Unipolar magnetic energy and “the monopole” becomes a “free agent” that can be absorbed, stored and aggregated by super-capacitors.
The amount of electric potential obtained in the form of induced electrical current, under this method is a function of the voltage potential and the frequency of the electrical-magnetic Vacuum-fluctuation pulses.
Electrical Potential in the Form of Induced Currents can be Generated from Inductors

As per Einstein's General Theory of relativity within the framework of Special Relativity (SR) and the ZPE energy plenum and as per the Mass-energy Equivalence principle, a change of mass produces a change of energy.

Electrical potential, in the form of monopole induced currents, can be generated by pulsing inductor members with electrical-magnetic potential disturbances which sets forward an “electromagnetic fluctuation radiant” event in the local space-time plenum which increases the implied mass of the inductor by the radiating of electrons (negative mass) increasing the current of the circuit and receiving an energy potential transfer from the ZPE General space-time in the form of Unipolar induced currents which can be converted to bipolar usable electrical potential using super-capacitors.

The Unipolar energy conversion occurs at high frequencies using the Casimir effect and it is stored in a an aggregated manner by using super-capacitors to store it.

### Vaccum-Fluctuations as Emf Radiant Field Events

Inductors being energized (or de-energized) by electrical potential will produce an unbalance in the form of a “vacuum-fluctuation” (magnetic disturbance) in the fabric of the ZPE energy plenum which indirectly creates an unbalance in the local space time which in turn evokes the need an adjustment to the ZPE General space-time plenum which will consume time. Thus, any information about the sudden change in motion cannot be updated any faster than the maximum speed c allowed by relativity.

This leads to the creation of a electromagnetic adjustment event in the ZPE General space-time to balance the mass and time. A change of mass in the local space-time will always produce an energy change.

In this case, the local space-time radiates negative electrons which increases the mass of the system (by diminishing the negative mass), and space-time finds necessary to compensate for the change in implied mass of the electromagnetic system by inducing an electrical current in the form of Unipolar induced current.

A change of implied mass carries the information about the charge's sudden surge of acceleration. Thus acceleration produces a vacuum-fluctuation disturbance in the WE energy Fabric which expands at speed c, but has a constant thickness equal to cΔt, where Δt is the duration of the acceleration and where time is always involved.

### PRIOR ART

The PRIOR ART is represented by the commonly known Electrical battery, generally of chemical nature which holds chemical electrolytes, which uses ion exchanges in the chemical electrolytes as the main source of ion potential. The chemical battery represents the PRIOR ART and it is used today to start automobiles, and to power a multitude of devices such as computer laptops and a great variety of devices and all within the “common knowledge” of the holder that eventually the electrical battery will have to be re-charged from an exterior source.

The NEW ART as ZPE Magnetic batteries does not use chemical ions as main fuel but produces “current magnetic ions” by borrowing electrical ions from a DC source to provide the electrical potential. The DC source could be chemical batteries.

The NEW ART uses ZPE obtained from the ZPF magnetic field which surround us as the potential as a result and via the oscillation of inductors which extract “ZPE potential” from the surroundings.

Also as part of the discovery of this patent, it is here shown that an inductor member when electrified (de-electrified) with a high frequency electro-magnetic disturbance will form their own electromagnetic “monopole” and will send energy in the form of Unipolar current from the ZPE environment. The potential generated by inductors is potential in the form of aggregated Unipolar potential, the Unipolar potential is collected thru the use of super-capacitor banks.

The potential practical applications of the new patent's concepts are many and they vary from electrical potential generation to direct driving of multi-phase motors for transportation but very especially FIG. 200 deals with a very especial application of the principles for Regenerative levitation system based on the concepts of the patent which could power future trains that use ZPE current energy for levitation and which is self-powered.

Most of our electrical applications today use bipolar potential (have a negative and a positive poles creating a differential). Our world deals mainly with bipolar forces, on the other hand raw electromagnetic energy in the General space-time is mainly Unipolar in nature.

The patent describes the apparatus call a ZPE Magnetic battery which provides potential in the form of the bipolar usable energy.

The patent keys on the facts that:
(a) PRIOR ART batteries are chemically bound and consume the positive ions to provide potential.
(b) This patent representing the ZPE Magnetic battery taps into the energy of the in the ZPF and the ZPE plenum thru the creation and utilization of “Vacuous-fluctuation” as electromagnetic disturbances.
(c) This patent presents a method to generate electrical potential by using electrical-magnetic pulsed disturbances which creates “Vacuum-fluctuations in the form of electromagnetic monopoles” which produces a continuous method to obtain potential from an electromagnetic radiant high frequency cycle and which allows the recovery of the initiating potential.
(d) An electromagnetic radiating event produced by an inductor radiates electrons (negative mass) which produces an implied mass increase effect which sets forward a transfer of energy from the ZPE General space-time in the form of Unipolar magnetic induced energy currents.
(g) The ZPE Magnetic battery harvests current potential thru the use of inductors which invoke the ZPE potential and super-capacitors which storage and convert it usable bipolar energy following the Casimir effect theory.
(h) The amount of usable potential produced by the ZPE Magnetic battery is a function of the frequency of the vacuum-fluctuation pulses, and the size of the battery source and its inductor components.
(i) This patent recognizes that ZPE Unipolar induced currents are also generated thru the principle of operation of some other devices such as the homo-polar generators which also generates high amounts of Unipolar induction currents. This patent recognizes that such devices also produce Unipolar currents that act like “dynamic magnetic monopoles” which can also be converted to usable bipolar energy thru the use of super-capacitors.

### TECHNICAL BACKGROUND

In 1831, shortly after his discovery of electromagnetic induction, Michael Faraday carried out an experiment with magnets rotating around its axis. A cylindrical steel magnet was hung vertically with its lower pole immersed in a bottle of mercury. When the cylindrical magnet was made to rotate about its axis, a continuous current was observed in a galvanometer. This compares similar with an earlier experiment performed by Ampere in 1821; in the similar circuit arrangement if the galvanometer was replaced by a Voltaic pile (DC battery) so that a current is driven round the circuit, the cylindrical magnet is found to rotate spontaneously about its own axis.

In 1841 Weber, who studied the phenomenon, christened the Unipolar induction effect because he believed that “only one” of the poles of the magnet was present in its induction effect.

It turned out very difficult in the nineteenth century to determine and explain unambiguously the nature of such currents, and the theory of electromagnetism was not sufficiently established for it to be able to understand the phenomenon at-hand just on the theoretical grounds alone.

It was only in the twentieth century, with the general acceptance of Maxwell's equations, the electron theory of Lorentz and the principles of relativity, that a consensus on Unipolar induction could emerge. Although there was much confusion in the early years about the theory of Unipolar induction, the notion of a mono-polar type of magnetism has been finally accepted including the recognition that the Unipolar induced magnetic effect actually exists.

The all mighty Unipolar current of this patent has been labeled useless in the past and it has remained in the shelf for two hundred years because our society has found it useless in its “mono-polar or Unipolar” form.

We can say that the method to use Unipolar magnetic current induction of this patent is integral part of the method to tap of the electromagnetic energy of the Universe

### The Mechanics of an Inductor Induced Current as Per Lenz's Law

This patent is concurrent with Lenz's law which says that, if you try to start current flowing in a wire, the current will set up a radiant magnetic field that opposes the growth of the induced current and it establishes a current in the opposite direction. This produced by the space-time which doesn't like being disturbed by accelerating charges like moving electrons, or similar charged particles which may change or unbalance the dynamics of the General space-time plenum and thus nature attempts to neutralize the “motion of the charged particle” to maintain a “magnetic status-quo”.

This is the Law and mechanics of the General space-time, it will protect the fabric of Space and Time of the General space-time at any cost and it will activate counter-measures in the form of energy magnetic monopoles containing magnetic Unipolar currents to neutralize any distortion which may be going on.

At the electrical circuit level, whether the charged particle accelerates or decelerates, an electrical circuit will be supplied with the General space-time's counter-measured magnetic energy required to attempt to neutralize the motion by radiating an Unipolar induced current.

This additional magnetic energy will be stored in the inductor temporarily as long as the local source is connected and as long as the magnetic field is sustained by the current. Such energy is returned back as free agent when the current is stopped and the field collapses and we call that “back emf”. This is relatively well known. What has been not known about back emf, is that is a not a complete “bipolar energy” instead is a monopolar Unipolar induced current. Unipolar induced currents have little practical use to us unless properly added electrical potential is added and it is stored and converted to bipolar usable energy.

When power is first applied, the inductor refuses to allow any current to flow. The current pretty much is zero just after switch-on. Thereafter it begins to rise, following an exponential curve towards its final value of V/R. The equation for the power absorbed by the inductor is the product of the voltage across it and the current flowing through it. Then, since the current i is changing as the magnetic field builds up, by aggregation, all these different values of i from switch-on to the steady state current I=V/R represent the total power.

A current growth situation develops where the induced current begets more induced current. The energy needed to supply this power has been supply to the circuit to initiate the process but once induction of current occurs, the General space-time pours monopolar magnetic energy to balance it, there is now stored in the inductor's magnetic field for as long as the electrical field persists. When the magnetic field collapses, the circuit will return all the Unipolar induced current back to the circuit as a free agent. The free agent Unipolar induced current can then be converted to usable bipolar potential.

Because the process can occur at frequencies of thousands or hundreds of thousands of cycles per second, the amount of bipolar energy generated is only limited by the size of the apparatus and the frequency at which operates.

It is very important to highlight the origin, the properties and the source of the magnetic energy to justify the objective of the patent.

Contrary to past knowledge, the magnetic energy provided to energize an inductor to produce Unipolar induced currents is provided by the General space-time as a remote source, the local source separately provides bipolar currents to the circuit, thus the General space-time currents have to have more power to balance the local source currents,

This effect alone makes possible the possibility that the Unipolar magnetic energy be recovered at great frequencies thus the circuit as used in this patent becomes a tool of special use to extract bipolar energy from the General space-time.
Compliance with the Second Law of Thermodynamics

As predicted by the Entropy law, usable work can be extracted from an alternating reversible entropic engine without violating the laws of Thermodynamics where all is required is two functions that change the energy's form back and forth between two states where the total net entropy change is zero and thus usable work can be obtained from the circuit without discharging the energy sources (as net zero energy work process) and without violating the Second law of thermodynamics.

### SUMMARY OF THE INVENTION

According to the PRIOR ART present chemical batteries are faulty and wasteful. Chemical batteries consume positive electrical potential powering electrical loads while doing positive work which produces negative potential which consumes the positive ions of the chemical battery.

It is an object of the present invention to provide an improved ZPE Magnetic battery which consumes negative potential in the form of positive electric currents which produces positive potential when doing negative work which does not discharge the DC source.

Briefly, the ZPE Magnetic battery uses oscillated inductors at high frequencies as one (1) Input ZPE converter which extracts negative potential in the form of Unipolar induced current from the ZPF which maintains a super-capacitor bank charged as a new source of potential and a second Output ZPE converter which returns the positive potential to the DC source while injecting Unipolar induced current to supplement the DC supply with additional current potential.

According to the attached NEW ART main embodiment, the patent describes an apparatus called a ZPE Magnetic battery which uses temporarily (borrows) the electrical potential of a DC source into a ZPE Magnetic current potential which taps into the ZPE and ZPF which does not destroy the positive ions.

In contrast the NEW ART as ZPE Magnetic battery provides electrical energy without consumption of chemical positive ions.

According to the NEW ART of the patent, it is possible to have a ZPE Magnetic battery which taps into the Space-time fabric of the General space-time for energy (Vacuum-fluctuation plenum) for potential.

According to the NEW ART of the patent, unlimited energy can be tapped from the ZPF using Vacuum-fluctuation plenum as described by the ZPE theories using the Casimir effect principles to generate an electrostatic type of electrical pressure thru the use of Unipolar potential stored in super-capacitors which promotes the acceleration of electrically charged particles.

According to the NEW ART of the patent, the Casimir effect produced by the storage of Unipolar potential stored in Super-capacitor which produces a “pressurized” electrostatic electrical energy which acts just like regular electrical potential

According to the NEW ART, positive current potential can power electrical loads doing negative work which produces positive potential.

Note: It is important to mention that the patent meditates the use of Flyback converters using a transformer to increase voltage output in lieu of a single inductor.

### BRIEF DESCRIPTION OF THE DRAWINGS

The drawings illustrate preferred embodiment of the methods and devices of the discovery and the reference numbers in the drawings are used consistently throughout. New reference numbers in FIG. 199 are given the 100 series numbers, FIG. 200 are given the 200 series numbers and so on. Similarly, new reference numbers in each succeeding drawing are given a corresponding series number beginning with the figure number, as follows:

FIG. 101a depicts the PRIOR ART Electrical battery.

FIG. 102a depicts the NEW ART ZPE Magnetic battery.

FIG. 103a depicts the PRIOR ART Electrical battery electric-current dipole.

FIG. 104a depicts the NEW ART ZPE Magnetic battery current-electrical dipole.

FIG. 100b depicts the NEW ART which invokes an induced free Unipolar energy. response from the ZPE via Vacuous-fluctuation plenum using an inductor.

FIG. 100c depicts the NEW ART ZPE Vacuum fluctuation generator free method of obtaining an Unipolar ZPE potential from an inductor.

FIG. 100d depicts the NEW ART method to transfer energy from ZPE Vacuum to super capacitors engine using the Casimir effect.

FIG. 100e depicts the NEW ART as a whole image of the Inductor/super-capacitor ZPE Vacuous-fluctuating effect working with the Casimir effect to produce a free energy engine.

FIG. 100f depicts the NEW ART free energy conversion method using the Unipolar to bipolar converter module.

FIG. 100g is a detail drawing of the NEW ART ZPE current generator cell circuit (ZPE Cell).

FIG. 100h is a detail drawing of the NEW ART ZPE current generator process.

FIG. 100 is a depiction of the NEW ART of the ZPE Magnetic battery as a device.

FIG. 200 is a detail of the Regenerative Levitation System using the ZPE cell concept.

FIG. 300 is a detail for Super-capacitor bank balancer.

### DESCRIPTION OF THE PREFERRED EMBODIMENTS

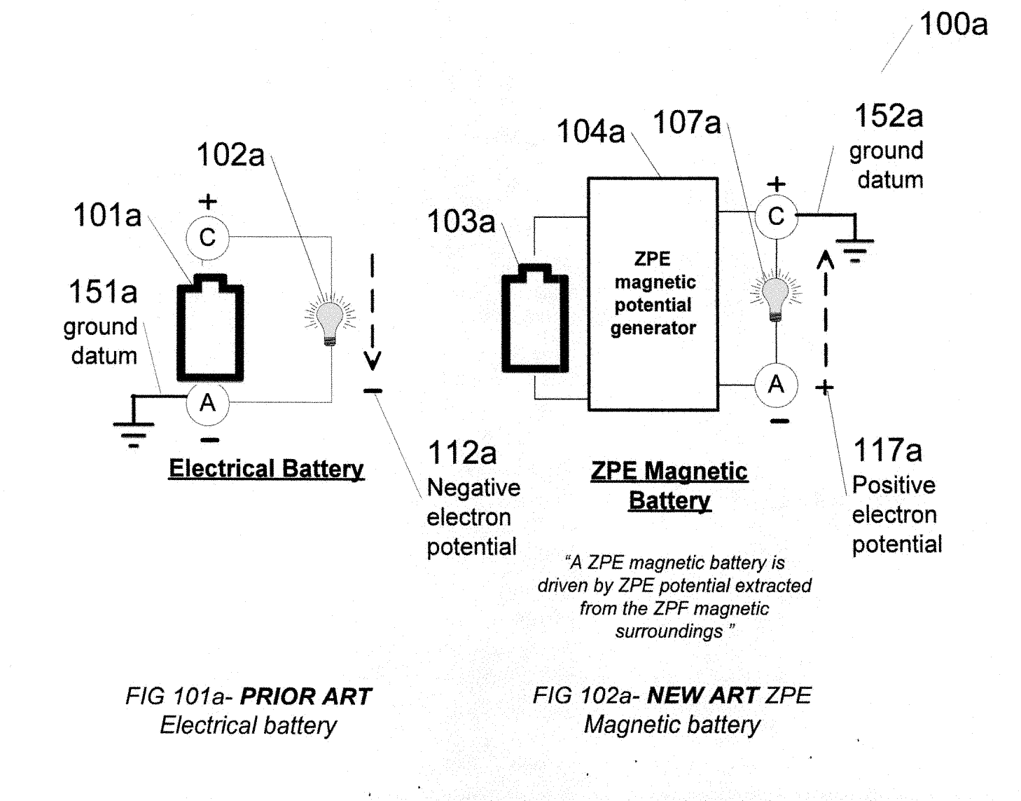

FIG. 101a depicts the PRIOR ART Electrical battery. Most batteries today hold a potential charge in the chemical electrolytes which is generally charged with positive ions, the battery does work in an exchange of positive ions (positive potential) working against a negative current (negative potential) thus generating negative potential. Any work done by the positive charge as positive potential will convert into negative potential which aggregates and discharges the battery. The chemical aspects have been extensively studied and practiced for over 100 years. The continuous burning of the positive ions eventually renders the battery unusable until another charge from an exterior source is used to re-charge the positive ions of the battery's electrolyte.

FIG. 102a depicts the NEW ART ZPE Magnetic battery. The new art uses at least two (or more) ZPE Converter circuits which inject unipolar positive induced current obtained from the electromagnetic surroundings using ZPE principles which inject free positive induced current into the circuit as positive potential into the electrical circuit.

A 100 ZPE magnetic battery is made out of five key components as 103a DC source (which may be AC converted to DC), 104a Input and 106a Output ZPE Converter cells and a 105a Super-capacitor bank which may include several units in parallel or series.

The 105a Super-capacitor, as a source, delivers positive potential at the anode and negative potential at the cathode (from electrical potential stored as negative). The main positive potential is made out of the unipolar induced current which serves to drive the 107a Load.

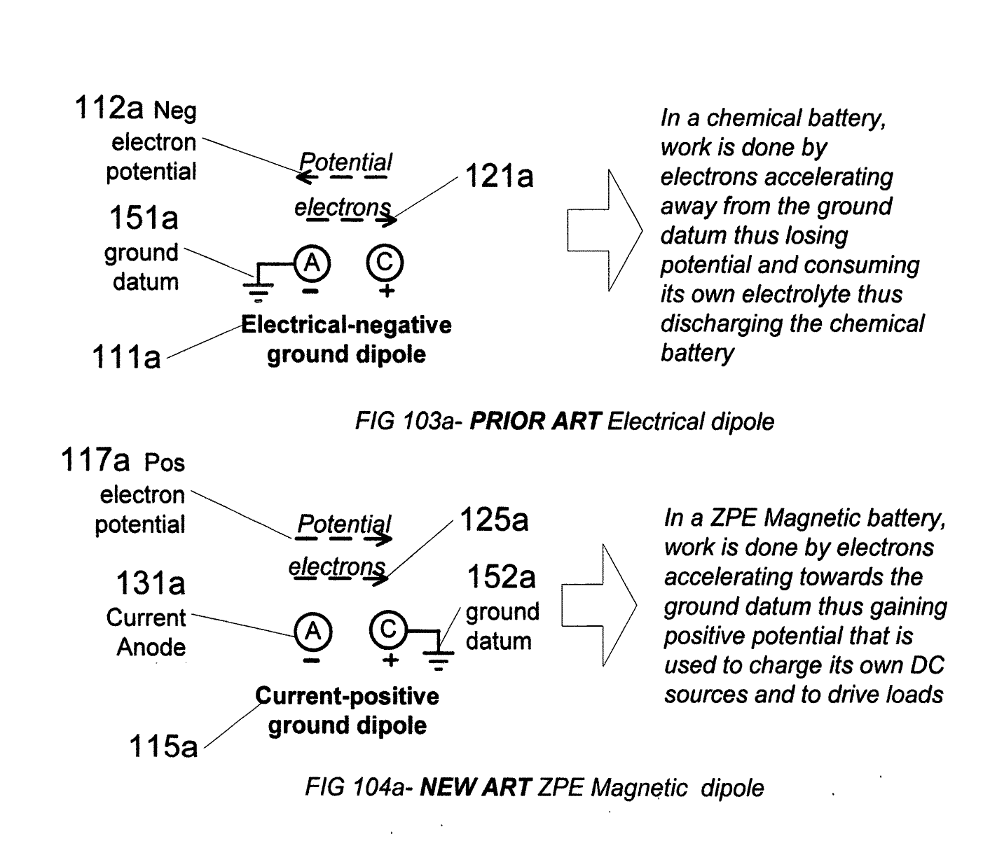

FIG. 103a depicts the PRIOR ART 111a Electrical battery electric-ground dipole. The 111a Electrical-current dipole contains an anode made out of positive electrical potential and a grounded cathode. The anode contains primarily positive potential in the form of electrical potential. Any work done by the battery will consume the positive ions of the anode thus consuming the electrolyte charge of the source.

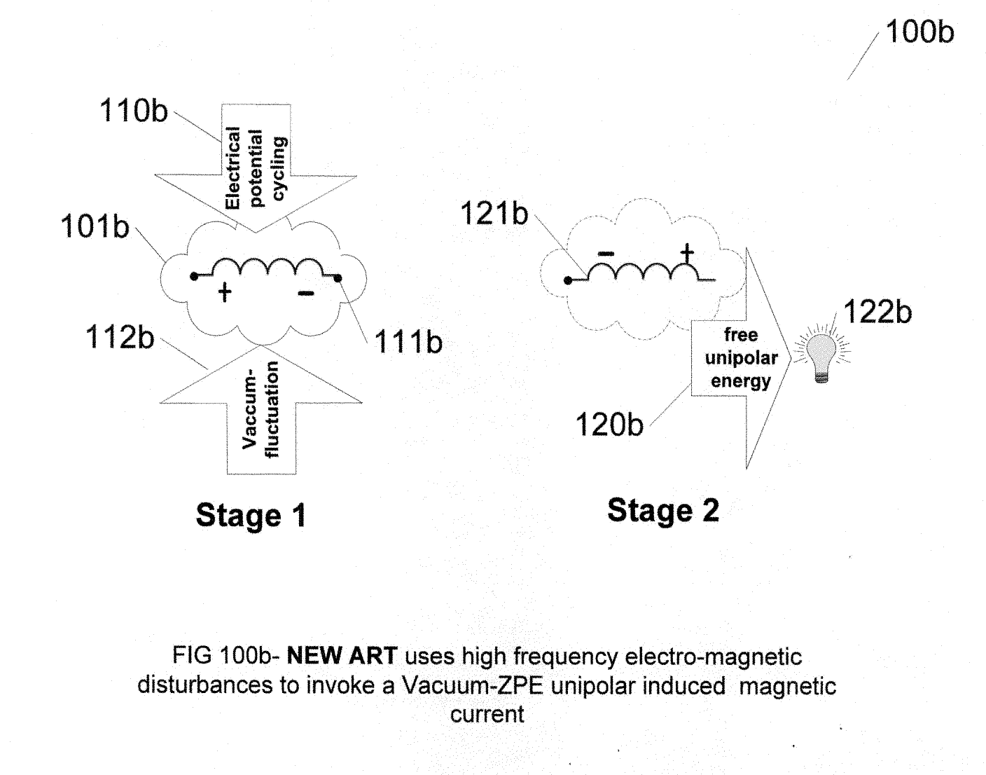

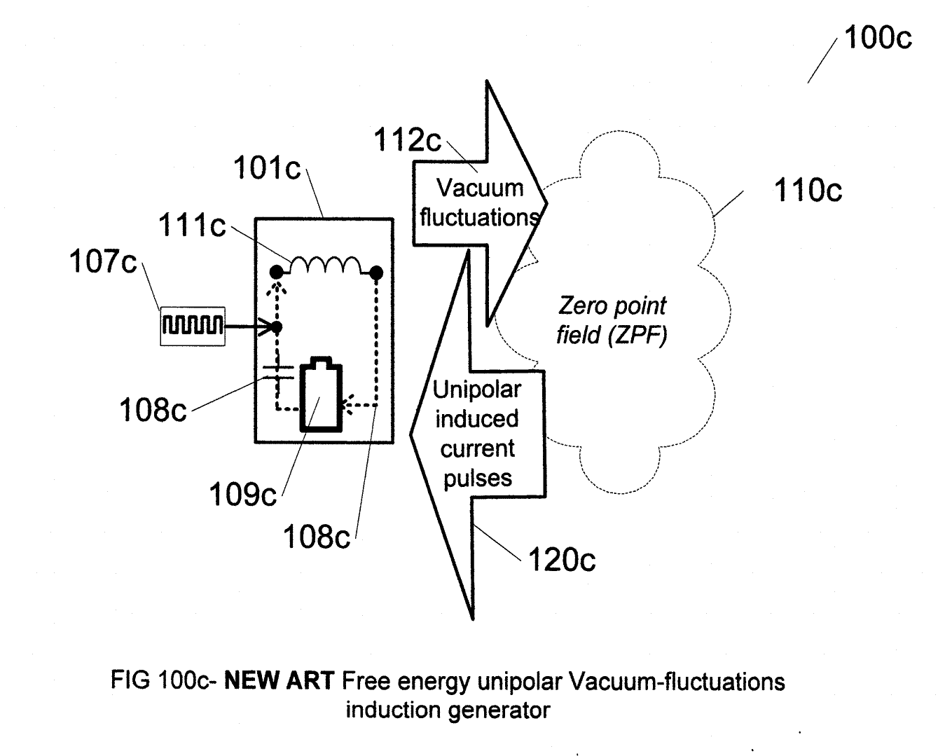

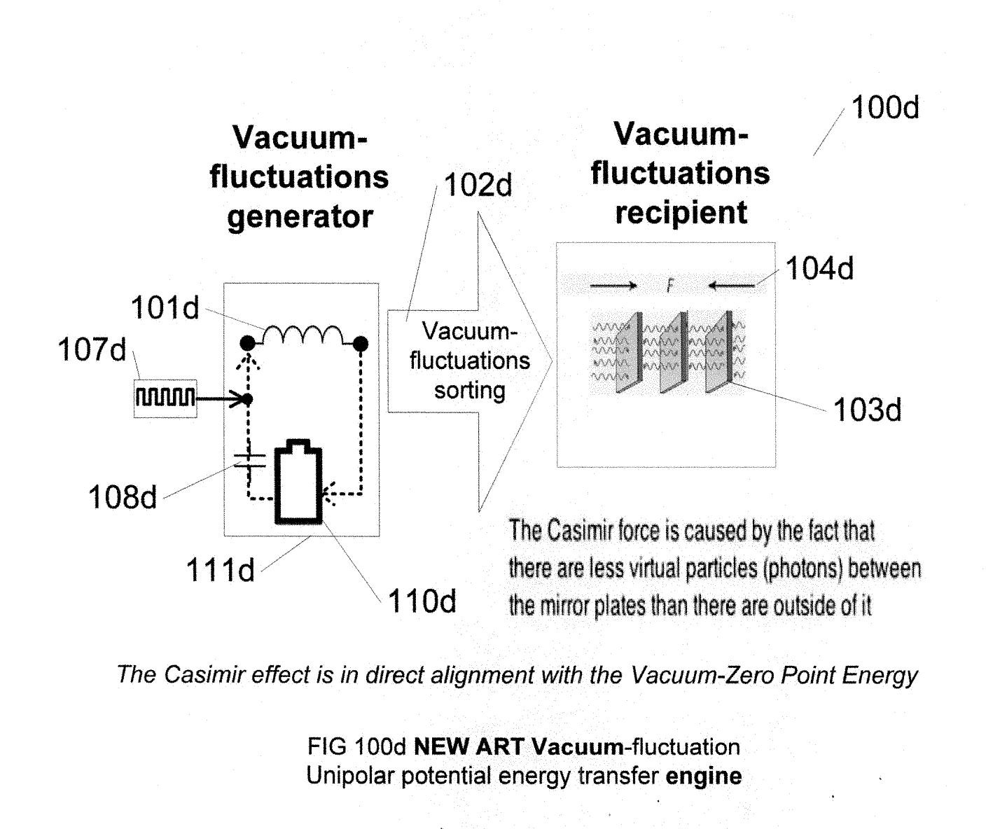

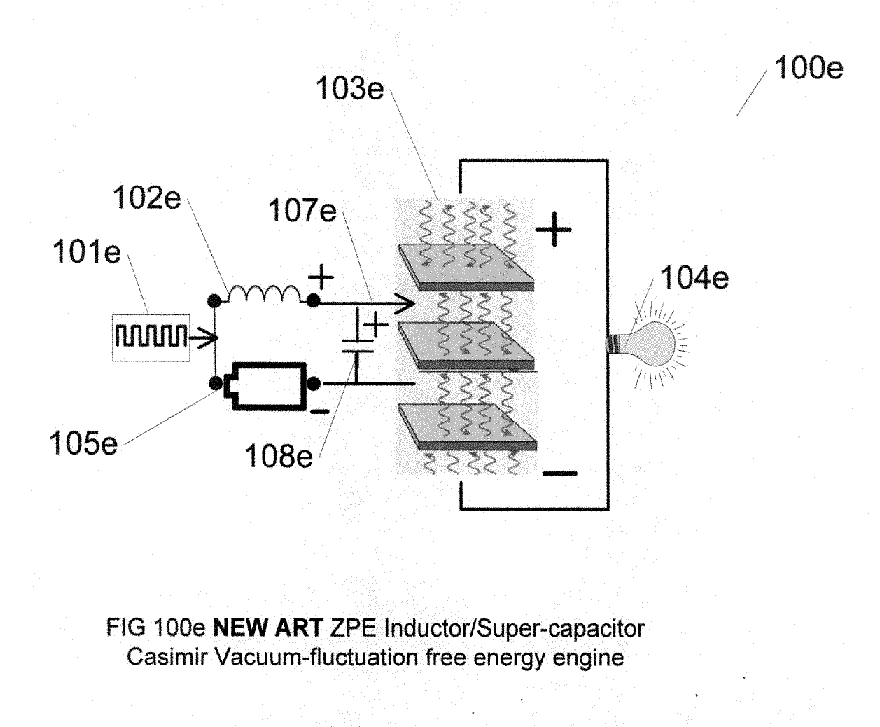

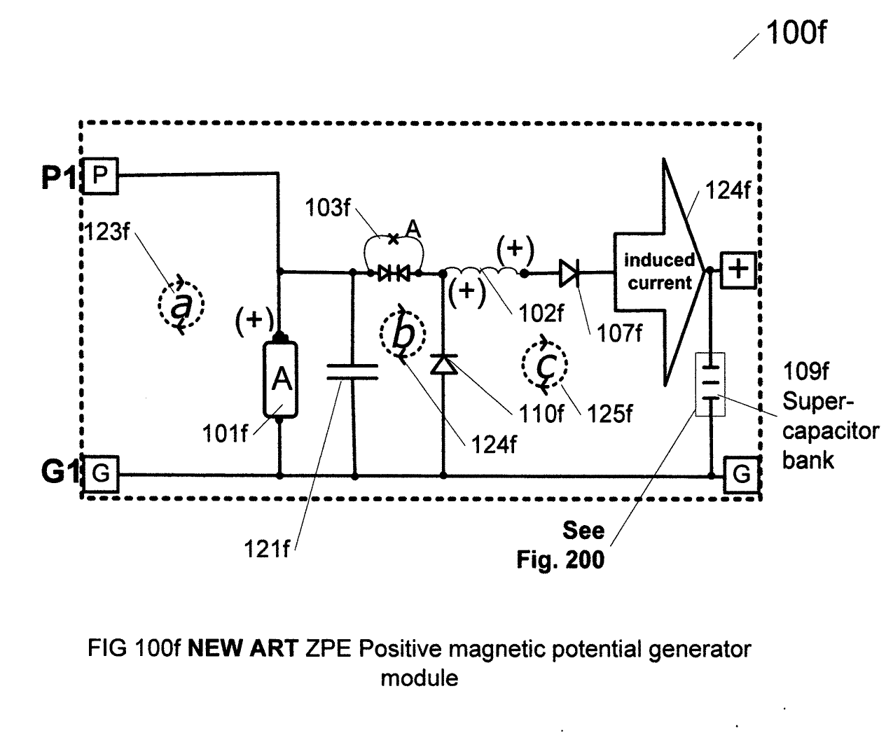

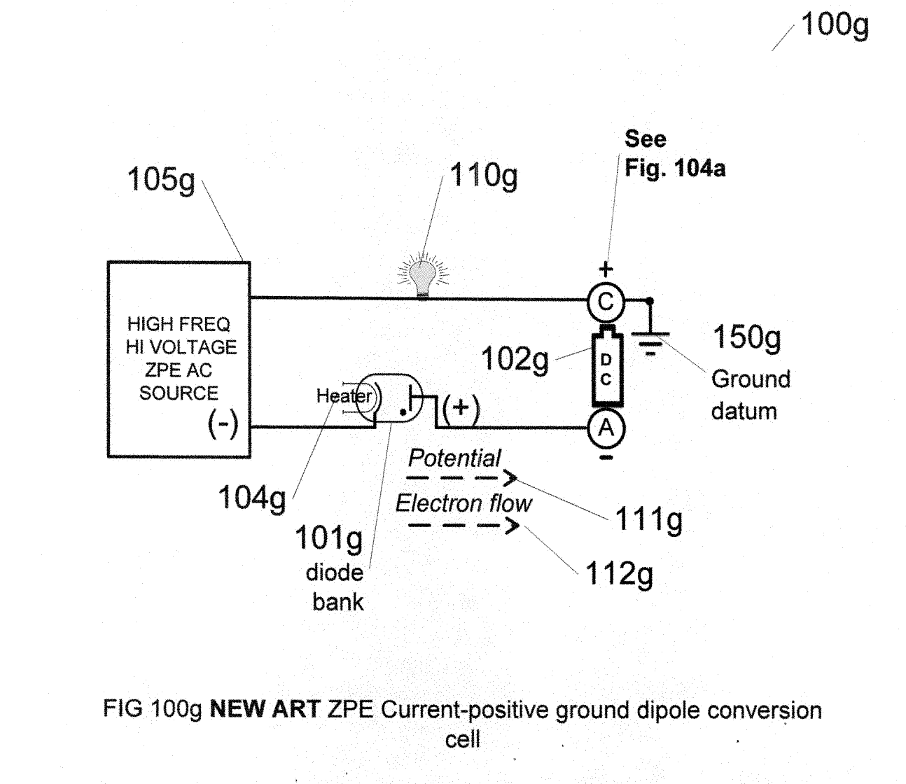

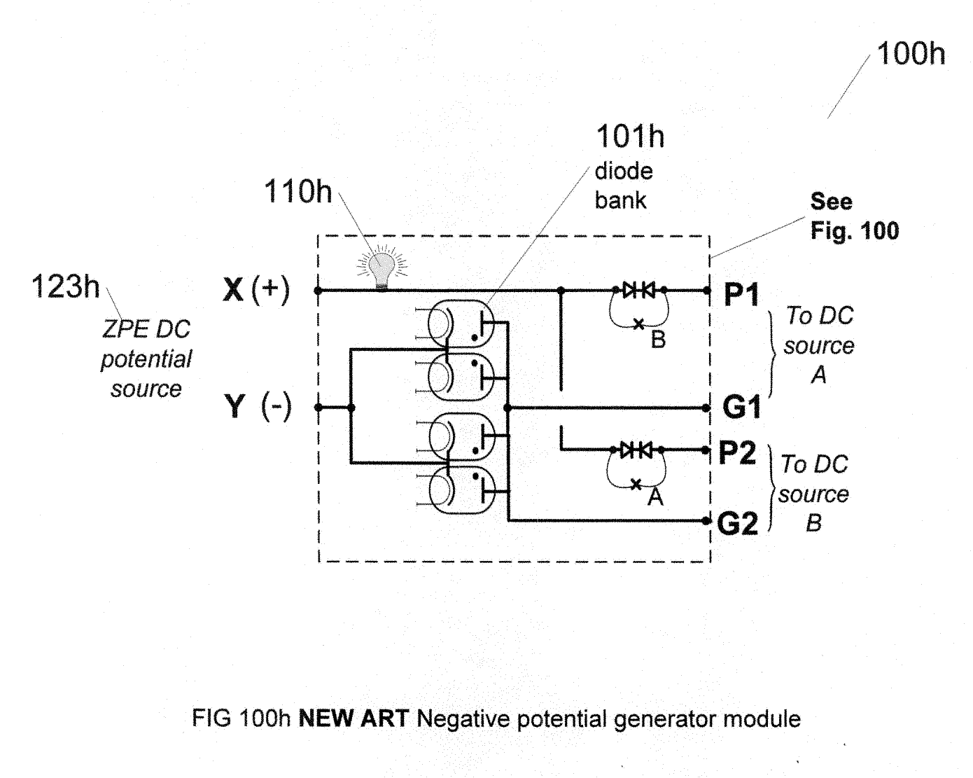

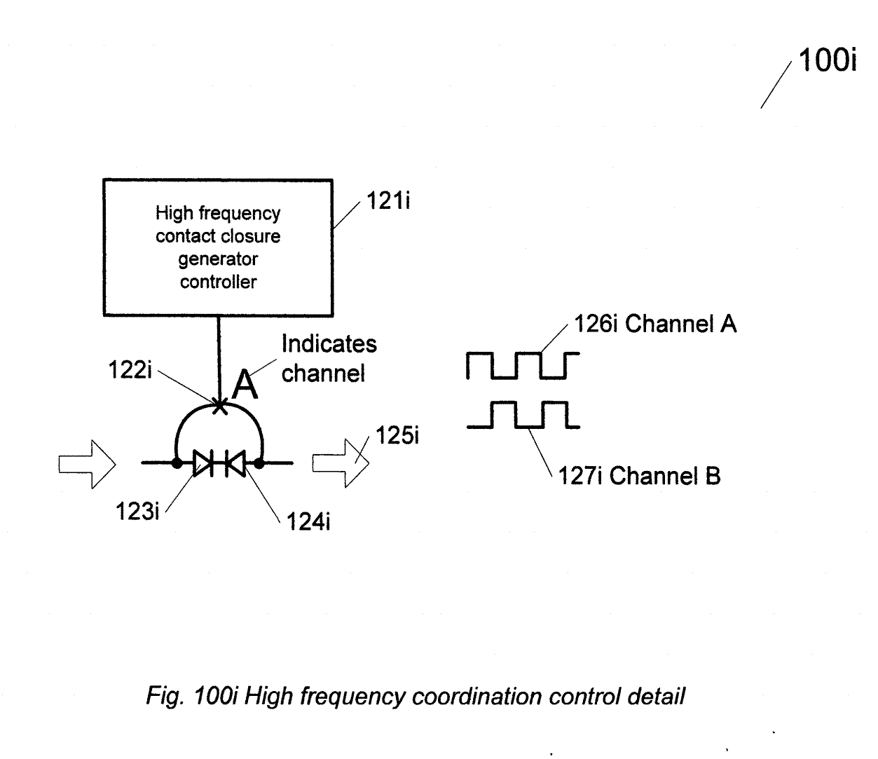

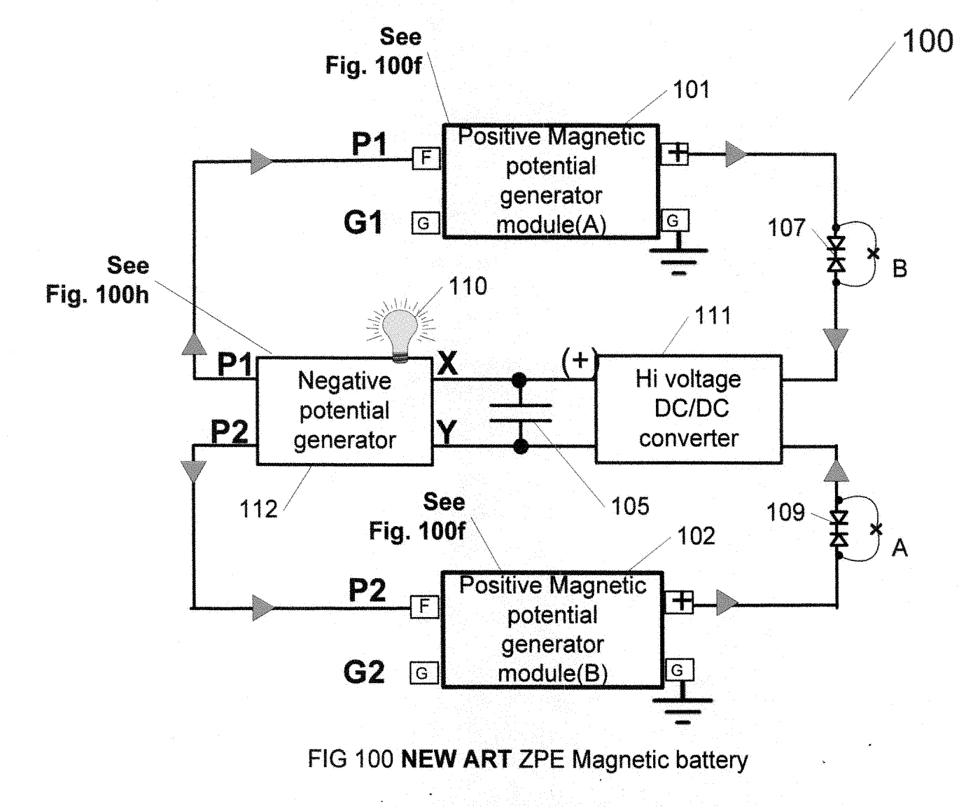

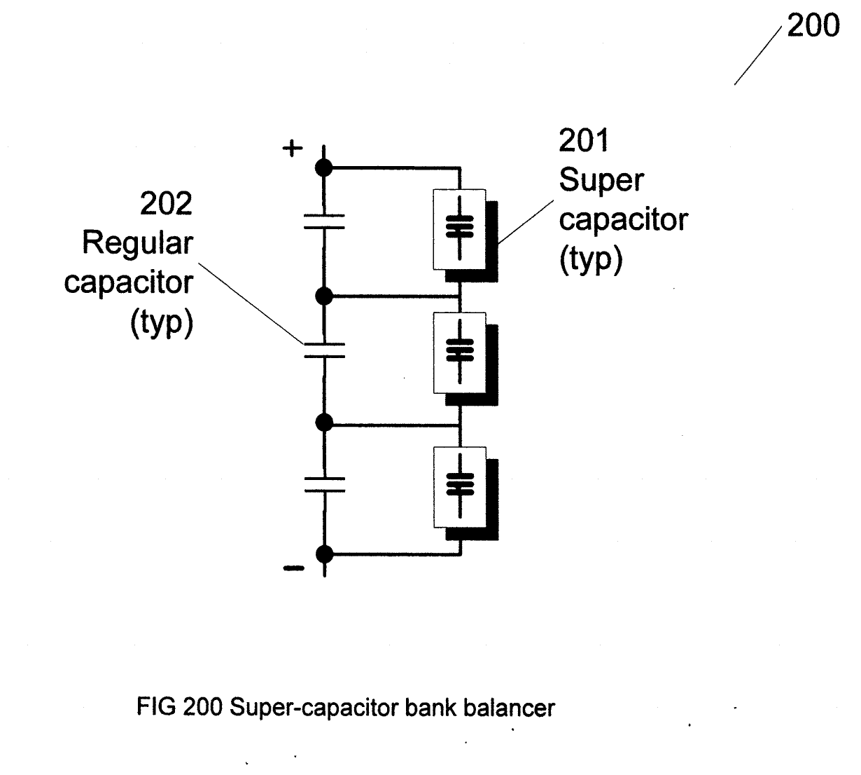

FIG. 104a depicts the NEW ART ZPE Magnetic battery current-ground dipole. The 112a Current-ground dipole contains an anode made out of positive current potential and electrical potential which has been stored. The anode contains primarily positive potential in the form of positive current potential. The potential source, in this instance, is a 105a super-capacitor which holds positive induced current potential obtained thru an inductor when oscillated at high frequency from the ZPE environment at the anode as positive potential and electrical energy. Any work performed by the Magnetic battery current-ground dipole converts the positive magnetic current of the anode to excess positive electrical potential which is aggregated to the potential as electrical energy gained.

Work performed by the current-ground dipole converts the magnetic current of the anode to excess positive electrical energy which is ultimately returned to the DC chemical battery via the 106a Output ZPE converter cell which also collects additional unipolar induced current to replenish the 103a Electrical source.

FIG. 100b depicts the NEW ART process which recovers 120b “free energy” from space-time via Vacuum-fluctuations which invokes an Unipolar induced currents of higher potential. FIG. 100b also made up of two stages as Stage 1 and stage 2 depicts the general process.

Stage 1 of the 100b process includes an 111b inductor electrical member which receives continuous and steady 112b DC electrical potential which produces a 110b local magnetic “bubble” in the form of a local Euclidean structure which disturbs the 101b ZPE space-time-vacuous energy around the 111b inductor in a manner similar to mass disrupted by gravity and vice-versa.

Stage 2 of the 100b process occurs after a 122b vacuum-fluctuation has been introduced and now, the same 121b inductor returns the 123b Unipolar induced current electrical potential to the source and kicking-out the excess stored free energy in the form of 110b Unipolar current induction which now has reversed polarity (negative to positive) and which has become the 120b “Unipolar free energy agent” which has monopolar current properties. The uniqueness of this “back emf” potential, in general, is that we have failed for two hundred years to recognize that “back-emf” exists in Unipolar current energy format which is most likely the energy format standard of the universe.

FIG. 100c depicts the NEW ART ZPE Vacuum-fluctuation generator sub-system free method of obtaining an Unipolar ZPE potential from an inductor.

FIG. 100c represents a ZPE Vacuum-fluctuation generator sub-system made out of a 111c Inductor, a 108c capacitor, a 109c power source and a 107c high frequency contact closure control system where contact closures at high frequency unbalances the steady state of the of the circuit formed by 111c Inductor and the 108c capacitor in series with 109c Power supply.
High frequency disruptions of this circuit will cause electro-magnetic fluctuations in the form of an Euclidean force magnetic field (electro-magnetic disturbances) which returns “free energy” in the form of 120c Unipolar induced potential current-

The 120c Unipolar energy response becomes “free energy agent” when the electromagnetic disturbance ceases and the potential originally used by the inductor is returned to the 110c DC source in the form of a higher current pulses.

Output 120c becomes Free energy in the form of Unipolar induced current that carries “pure” monopolar energy. This energy can be stored in super-capacitors which converts the positive currents to positive potential and the electrical energy to negative potential.

FIG. 100d depicts the NEW ART method to transfer energy from ZPE Vacuum to super capacitors engine using the Casimir effect.

The 111d Vacuous-fluctuations generator is comprised of a sub-system made out 101d Inductor, a 108d capacitor, a 110d DC source, and a 107d High frequency high voltage pulse generator. The 111d Vacuous-fluctuations generator which operates at high frequency produces an electromagnetic Vacuum-fluctuation type of disturbance around the 101d inductor which prompts the ZPE energy Vacuous-space to produce an Unipolar induced current response (Faraday's) which is an electromagnetic counter-measure natural response which contains a higher current potential. The 102d vacuum-fluctuation is “pure” induced magnetic energy. The 111d Vacuous-fluctuations generator are stored the 103d Super capacitor.

The 103d Super capacitor (which is most likely a super-capacitor bank) receives the 102d Unipolar induced potential and stores its energy thus creating a 104d Casimir effect force which produces an electrostatically pressurized potential form while at the same time converts the Unipolar to usable bipolar electrical potential.

FIG. 100e depicts the NEW ART as a whole image of the Inductor/super-capacitor ZPE Vacuous-fluctuating effect working with the Casimir effect to produce a ZPE free energy engine.

The received energy is in the form of 107e positive potential and 108e negative potential which by the principles of the Casimir effect it creates an electrostatic bipolar pressure.

“By applying Unipolar induced current mixed with electrical potential to the conducting plates of a super-capacitor, a very large internal electrostatic force is introduced which opposes the natural internal Casimir forces of the super-capacitor which can be stored as bipolar usable electrical potential to do work”.

FIG. 100f depicts the NEW ART free energy Casimir effect conversion module which converts and stores the harvested Unipolar to bipolar potential. The free energy conversion module shown on FIG. 100f is made out of a 102f DC supply, the 101f Inductor, the 109f capacitor, the 112f contact closure switch, the 110f and 120f diodes and 106f Super-capacitor which stores the potential.

The 100f Free energy ZPE conversion module receives a high frequency contact closure via 112f switch which may be local or central. The 100f Current conversion module produces a free energy 103f Unipolar induced current which carries the energy to the 106f Super-capacitor. The 106f Super-capacitor stores the 104f positive Unipolar potential as 104f as well as the positive electrical potential as positive potential relative to a negative ground.

The 107f net final potential is produced as a bipolar usable electrostatic pressurized type of electrical potential which behaves like the common electrical energy which when doing work consumes the current and increases the electrical potential. And which current potential can be recovered and recycled for re-use.

FIG. 100g is a detail drawing of the NEW ART ZPE current generator cell circuit (ZPE Cell). The ZPE cell is represented by FIG. 100g, System 100g is made out of 115g DC source connection post, a 103g inductor, diodes 111g, 105g, 107g and 102g capacitor. The 107g module is driven by 109g contact closure which is controlled by a 101g Microprocessor based high frequency controller.

The 107g ZPE cell operates by maintaining the 103g inductor and the 102g capacitor in a state of continuously activation in a low burden displacement current state like holding a latent “magnetic bubble” produced by the 103g inductor while diodes 111g and 105g (connected inward) prevent electrical connection. The rate of release of “magnetic bubbles” and the production of the vacuum-fluctuation is controlled by 109g contact closure which is driven by 101g High frequency contact closure control acting at high frequency (10 kHertz-100 KHertz) bypasses the 111g diode thus creating a path which produces a very fast chain of magnetic Vacuum-fluctuation disturbances around the 103g inductor environment thus invoking the ZPE induced currents.

FIG. 100h is a detail drawing of the NEW ART ZPE current generator process. The ZPE current generator is made out of five (5) devices including 105h Load as 101h DC source, 102h Input ZPE converter, 103h Super-capacitor bank, 104h Input ZPE converter and 105h Load, all connected n series.

The 100h ZPE current generator operates cyclically in six (6) steps as follows:

Step 1—Electrical potential from 101h DC Source is supply to the circuit, as per 111h Electrical potential (+E) is delivered to the circuit without using any current (C=0).

Step 2—As per 102h Input ZPE converter injects 112h ZPE current into the circuit as (+Cz).

Step 3—As per 113h, the 103h Super-capacitor bank receives current (+Cz) and (+E).

Step 4—Work done by 105h produces a loss of current potential (−delta C) to electrical potential (+delta E) which results in a gain of electrical potential.

Step 5—As per 104h Output ZPE converter injects 115h ZPE current into the circuit as (+Cz).

Step 6—As per 116h, the 101h DC source receives gained current (+Cz) and original (+E) plus (Delta Ework) gained by doing work.

FIG. 100 is a depiction of the NEW ART ZPE Magnetic battery as a device. The 100 ZPE Magnetic battery is primarily composed of the following: 101 DC supply which may be solar, battery DC or converted AC sourced, 102 Input ZPE converter, 103 Super-capacitor bank, 104 Input ZPE converter and 105i Load, all connected in series. Each ZPE Cell (102 and 104) is driven by a high frequency (10 KHertz-100 KHertz) controller.

The 100 ZPE magnetic battery may have many ZPE converters in parallel using a single or multiple DC source in series and parallel thus increasing its output.

The 100 ZPE magnetic battery operates as a very clean DC current source which may have additional voltage conditioning to control the voltage output and the loads may be many types and sizes including laptops, computers as well as lighting systems as well as vehicles for transportation. The ZPE magnetic battery can also power homes as well as buildings.

The size of the DC source and the inductorsprimarily determines its output. The 105 Load may be a DC-AC Inverter thus providing AC output.

One of the greatest attributes of the 100 ZPE magnetic battery is that it does not produce any pollution or heat.

FIG. 200 is a detail of the Regenerative Levitation System (RLS) using the ZPE cell concept. The RLS is a levitation application of the principles of the application, where 201 vehicle frame is lifted by 202 inductors which are being pulsed electrical at high frequency in a synchronized manner, and where 204 vertical magnetic forces lift the 201 vehicle frame while horizontal lateral forces, shown as 203 developed by high frequency multi-phase motors of fans produce a horizontal thrust to levitate and move horizontally the frame which is directed by a continuous 205 ferrous metal rail. Because the system basically transfer magnetic energy from the General space-time ZPE vacuous-space, the system would have the capacity to maintain its batteries charged while providing locomotion to the vehicle frame.

FIG. 300 is a detail for Super-capacitor bank balancer. Super-capacitor banks depending on the size may have many units in order to provide the proper storage size for the application. It is recommended to use “balancing regular capacitors” to insure a homogeneous storage of the potential thru the several super-capacitors that may be required.

### TECHNICAL FIELD

This patent relates to ZPE Magnetic battery devices used to harvest electrical potential by converting Unipolar induced potential obtained from inductors members in a manner that taps into the general ZPE Vacuum-space-time exposed to vacuum-fluctuations which is converted to bipolar usable energy and stored in super-capacitors using the Casimir effect principle.

### TECHNICAL PROBLEM

There is a need for a ZPE Magnetic battery which uses the potential from DC sources without destroying the positive ions of the source while generating potential which can be used to power devices and which reclaims the potential for re-use to power electrical devices such as lights, laptop computers, electrical motors and other electrical or electronic devices without discharging the source.

### Solution to the Pollution Problem

Heat pollution is generated by our present practices to generate potential to power machines and devices because generically we are using “positive potential to do positive work which produces heat rather than doing negative work with negative potential which does not generate heat”, negative potential does have to come from fuel.

Part of the solution of the present global warming which affects humanity today is related to the pollution generated by our powering devices. The solution requires the substitution of the present energy generation methods with the new revolutionary concepts presented by the patent which are friendly to the environment.

Our present electrical generating system uses polluting fuels found in the earth primarily, these fuels are polluting our environment. This patent proposes the idea of electrical generating systems which taps into “an universal” space-time structure made out of energy itself.

Because the methods and apparatus discussed by this patent are scalable, it provides the opportunity for large and small generating systems of virtually any size that can power electrically our homes, air condition and heat our homes by using the same techniques to power electric induction units, provide energy to power induction heat units to prepare and cook food, procure clean energy for transportation means for electric cars, levitation for trains and other methods as well as the development of twenty four hour energy lighting systems that can help humanity to raise food as well as the conversion of sea water to drinkable water and the extraction of drinkable water from the moisture contained in air in the desserts.

What is claimed:

1. A ZPE Current converter module which converts DC potential to ZPE unipolar induced currents collected from the ZPF environment comprising:
a dual positive and ground termination posts which receive DC supply from an exterior DC source,
an electrical inductor member,
a regular capacitor,
a high frequency switch,
three (3) diodes,
a high frequency (preferably microprocessor based) switch contact controller,
a dual positive and ground termination posts to the exterior which carries the Unipolar induced currents collected from the ZPF environment as potential output to the exterior,
a first circuit, a second circuit and a third circuit in contact with said high frequency (preferably microprocessor based) switch contact generator,
the first circuit connected onto the said positive terminal post of the said DC supply to first side of the electrical inductor member, connected in series to a regular capacitor and connected to a diode arranged and connected to the ground terminal post of the circuit in such manner that the said high frequency circuit is continuously energized holding a “magnetized state” (magnetic bubble state) ready to be converted into unipolar induced magnetic current upon unbalancing,
the second circuit made out of two diodes connected in series diametrically inwardly connected in opposed position to each other which prevent connectivity holding the terminations posts to a normally open state thru the said high frequency switch contact which serves bridge by bypassing the second diode to make connectivity of the positive leg connection to the said positive output terminal post and a second leg continuously connected to the said ground output terminal post to export the electrical potential to the exterior,
the first and second circuit connected to the point of intersection of the second end of the said electrical inductor and the said regular capacitor and connected with a common ground which releases the said “magnetic bubble” potential to the said second circuit,
the third circuit holding connection to the exterior of the said normally open exterior high frequency switch of the second circuit to the said high frequency (preferably microprocessor based) switch contact generator,
means of oscillating the said first circuit at high frequency so as to cause abrupt “magnetic disturbances” (Vacuum-fluctuations) at high frequency which evokes an Unipolar induced currents response which can be used to power electrical load(s) when collected by super-capacitors.

2. The method of producing ZPE Vacuum-fluctuations of claim 1 by unbalancing charged inductors at high frequency producing electro-magnetic Vacuum-fluctuations disturbances which evoke usable unipolar induced currents energy from the ZPE space-time which are stored in super-capacitors banks using the Casimir effect which as potential to drive electrical loads.

3. The means of collecting and storing the unipolar induced currents output of the ZPE Current converter module of claim 1 into super-capacitors banks using the Casimir effect for driving external electrical loads.

4. The means of controlling the output of the ZPE Current converter module of claim 1 by adjusting the frequency of the said (preferably microprocessor based) high frequency switch contact controller.

5. The means of controlling the output of the ZPE Current converter module of claim 1 by selecting a variable inductor member.

6. A second circuit as in claim 1 wherein said opposed diodes switch is a SCR switch.

7. The means of the second circuit of claim 1 to have multiple said high frequency switches in parallel.

8. A ZPE Magnetic battery which converts electrical potential to magnetic current potential to power electrical loads using ZPE induced currents obtained from the ZPF magnetic environment comprising:
a DC power supply,
an Input ZPE Current converter module including its respective oscillating controller,
a super-capacitor bank,
an output ZPE Current converter module including its respective oscillating controller.
a common ground series circuit connected in an order to follow as to the said DC power supply, to the said Input ZPE Current converter module, to the said super-capacitor bank, to the said Output ZPE Current converter module which forms an electric circuit which produces a current-ground dipole at the said super-capacitor bank which powers exterior electrical loads with magnetic current potential instead of electrical potential from the said DC power supply.

9. The method of claim 8 which negates the consumption of positive ions of the said DC power supply.

10. The method of claim 8 which consumes the ZPE induced currents (negative potential) when powering electrical loads (negative work) producing positive potential which does not discharge the said DC power supply.

11. The means of the circuit of claim 8 to have multiple Input ZPE Current converter modules in connected parallel with proper electrical isolation means.

12. The means of the circuit of claim 8 to have multiple output ZPE Current converter modules connected in parallel with proper electrical isolation means.

13. The means of the circuit of claim 8 to have multiple ZPE Magnetic Batteries connected in parallel to increase electrical current output.

14. The means of the circuit of claim 8 to have multiple ZPE Magnetic Batteries connected in series to increase voltage potential output including proper voltage conditioning to match the load including a DC to AC inverter and or transformers.

15. The method of powering electrical loads using ZPE Unipolar induced currents obtained from the ZPF environment by using ZPE Current converter modules and collected by super-capacitors banks which consumes the collected magnetic currents (instead of consuming electrical potential) producing positive electrical potential which is routed and collected to the DC supply source.
